(19) United States
(12) Patent Application Publication
(10) Pub. No.: US 2015/0254167 A1
(43) Pub. Date: Sep. 10, 2015

(54) STRUCTURED SYNTAX FOR STORY SPECIFICATION

(71) Applicant: International Business Machines Corporation, Armonk, NY (US)

(72) Inventors: Eitan D. Farchi, Pardes Hana (IL); Aviad Zlotnick, Mitzpeh Netofah (IL)

(73) Assignee: International Business Machines Corporation, Armonk, NY (US)

(21) Appl. No.: 14/201,948

(22) Filed: Mar. 10, 2014

(51) Int. Cl. G06F 11/36

(52) U.S. Cl. CPC G06F 11/3684

(57) ABSTRACT

A computer-implemented method performed by a computerized device, apparatus and computer program product, the method comprising: displaying to a user two or more options related to one or more principle attributes of a test; receiving from the user selection for an option related to a principle attribute; receiving from the user a value for the principle attribute; and generating a description of the test, the description comprising the value for the principle attribute.

The present disclosure relates to testing in general, and to a method and apparatus for entering test descriptions in a natural language, in particular.

### BACKGROUND

Computerized devices control almost every aspect of our life—from writing documents to controlling traffic lights. However, computerized systems are bug-prone, and thus require a testing phase in which the bugs should be discovered. The testing phase is considered one of the most difficult tasks in designing a computerized device. The cost of not discovering a bug may be enormous, as the consequences of the bug may be disastrous. For example, a bug may cause the injury of a person relying on the designated behavior of the computerized system. Additionally, a bug in hardware or firmware of a marketed product may be expensive to fix, as patching it requires call-back of the computerized device. Hence, many developers of computerized systems invest a substantial portion of the development cycle to discover erroneous behaviors of the computerized device.

An important part of testing relates to test planning and design, i.e., providing a set of tests that adequately cover the system, such that if all tests pass, the system is assumed to be operative. However, it is generally required to increase testing efficiency and reduce the number or total cost of the tests as much as possible.

A common methodology for test planning and design comprises the usage of combinatorial models, also referred to as Cartesian-product models, which may be used when describing a problem as a set of attributes or properties, values corresponding to the attributes, and possibly restrictions on combinations of values that may not appear together in a test. Each test comprises a value for each attribute, such that the combination represents a particular situation. Thus, a test may be represented as a tuple in which every attribute is assigned a value. The model thus spans a space of valid tests, being the value assignments that do not violate any restriction.

Combinatorial models may be used as input to Combinatorial Test Design (CTD), a test planning technique that selects a subset of the valid test space which is required to cover all interactions up to a certain level, which may be user-defined. Another important usage is for analysis of functional coverage of systems.

In order to generate a combinatorial model, the tests have to be in an appropriate form, or at least translatable to the appropriate form of attributes and values. However, the best person for suggesting tests for a system under test is often an expert in the domain of the system, who is not necessarily familiar with the concepts of attributes and values. Even further, sometimes identifying the attributes and values is not a trivial task. Such expert may specify the tests using the terms and concepts common in the field, in some natural language or using a dedicated tool. However, the obtained tests may not be easily translatable to the attributes and values form required in order to apply combinatorial test design tools to the tests, to use test analysis tools, or otherwise use or investigate the tests.

### BRIEF SUMMARY

One aspect of the disclosure relates to a computer-implemented method performed by a computerized device, comprising: displaying to a user two or more options related to one or more principle attribute of a test; receiving from the user selection for an option related to a principle attribute; receiving from the user a value for the principle attribute; and generating a description of the test, the description comprising the value for the principle attribute.

Another aspect of the disclosure relates to a computer-implemented method performed by a computerized device, comprising: receiving a text representing a test; and parsing the text to obtain: one or more principle attributes and an associated first value, and one or more auxiliary attributes and an associated second value, auxiliary attribute associated with one of the principle attributes.

Yet another aspect of the disclosure relates to an apparatus having a processing unit and a storage device, the apparatus comprising: a user interface component for receiving from a user a selection related to a principle attribute and a value for the principle attribute; and a test description generation component for generating a test description, the test described as the value for the principle attribute.

Yet another aspect of the disclosure relates to a computer-implemented method performed by a computerized device, comprising: receiving a text representing a test; and converting the text into an attribute-value form tests.

Yet another aspect of the disclosure relates to a computer program product comprising: a non-transitory computer readable medium; a first program instruction for displaying to a user two or more options related to one or more principle attribute of a test; a second program instruction for receiving from the user selection for an option related to a principle attribute; a third program instruction for receiving from the user a value for the principle attribute; and a fourth program instruction for generating a description of the test, the description comprising the value for the principle attribute, wherein said first, second, third and fourth program instructions are stored on said non-transitory computer readable medium.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A and 1B show a table of texts presented to a user for building a test, user selections and user entered text, and the resulting test, in accordance with some exemplary embodiments of the disclosed subject matter;

FIG. 2 shows an exemplary graph representation of a natural-language generated test, in accordance with some exemplary embodiments of the disclosed subject matter;

FIG. 3 shows a flowchart of steps in a method for receiving a test description from a user, in accordance with some exemplary embodiments of the disclosed subject matter; and

FIG. 4 shows a block diagram of components of an apparatus for planning a test with order coverage requirements, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter relates to generating tests for a given system. Generally, tests should be generated and selected so as to reduce resources during testing, for example by reducing the number of tests as much as possible, while preserving a required level of testing.

In some environments, in order to use combinatorial testing tools, an attribute-value methodology for describing tests may be used, in which attributes describe entities or actions in a system, each attribute having one or more possible values. Each test in this methodology may thus be represented as a collection of attributes and corresponding values.

Once a corpus of tests is available, combinatorial testing may be used to select a subset of the tests that complies with the coverage requirements. Such requirement may be, for example, that every combination of values of two attributes needs to be tested. For example, in a system having four attributes A, B, C and D, wherein each attribute may be assigned 0 or 1, and wherein all combinations of A and B and all combinations of C and D have to be tested, a satisfactory test suit may comprise the values of {0,0,0,0}, {0,1,0,1}, {1,0,1,0} and {1,1,1,1}, wherein each tuple comprises values for A, B, C and D, in this order.

However, identifying the attributes and possible values in a system may not be easy. This task may require an expert in the field of the system, but such expert may not be familiar with the concepts of attributes and values, but may rather prefer to describe tests in a natural language. However, using free language may not allow the creation of structured tests from free text.

Thus, it is required to provide a system and method for a user to describe tests in a structured manner but in natural language, such that the user may feel comfortable, but the tests may be used with automatic systems. It is further required to provide a method for generating a collection of attributes and values from one or more tests, such that a test can be described as a collection of values for attributes, thus lending them to automatic tools such as combinatorial test design tools, test analysis tools, or others.

One technical solution comprises defining a basic set of principle attributes relevant for most tests in most systems. The set may include but is not limited to, for example, an actor being the person for whom the tested functionality is important, an action being the main operation of the test, an object being the subject of the test and a tool which may be required for taking the action.

A user may then be presented with options for entering a test, including values for the principle attributes. Each such principle attribute may also be associated with one or more auxiliary attributes, which describe or add details relevant to the principle attribute.

A user may then select the correct option, and enter a value for the option, wherein the value may be user-defined or selected from a predetermined list.

It will be appreciated that after a user has provided a value to a principle or auxiliary attribute, the value may later be suggested to the user or to other users when required to enter a value for the same attribute or to similar attributes.

After providing value to a principle attribute, the user may be required to select another attribute and provide a value to the other attribute, whether it is a principle or auxiliary attribute. The text comprising the selected options and user-selected or user-entered texts, optionally with some predefined texts constitutes a description of a test in a natural language. And may then be displayed to the user.

Accumulating the user input during test creation may be described as traversing a graph in which each attribute is represented as a node, and edges enable the advancements from one node to the other.

Once one or more tests are defined, a collection of values for each principle attribute and auxiliary attribute may be compiled. A representation of any test may then be provided as a set of values for one or more principle attributes, and optionally for one or more auxiliary attributes.

The attribute and value representation of the tests may then be provided to tools such as combinatorial design tools, test analysis tools, or others.

One technical effect of utilizing the disclosed subject matter is the provisioning of a structured way for a user to describe a test in free language. The attributes and values are then easily and automatically identifiable, such that each test may be automatically transformed to an attribute-value form, which can be used by automatic tools.

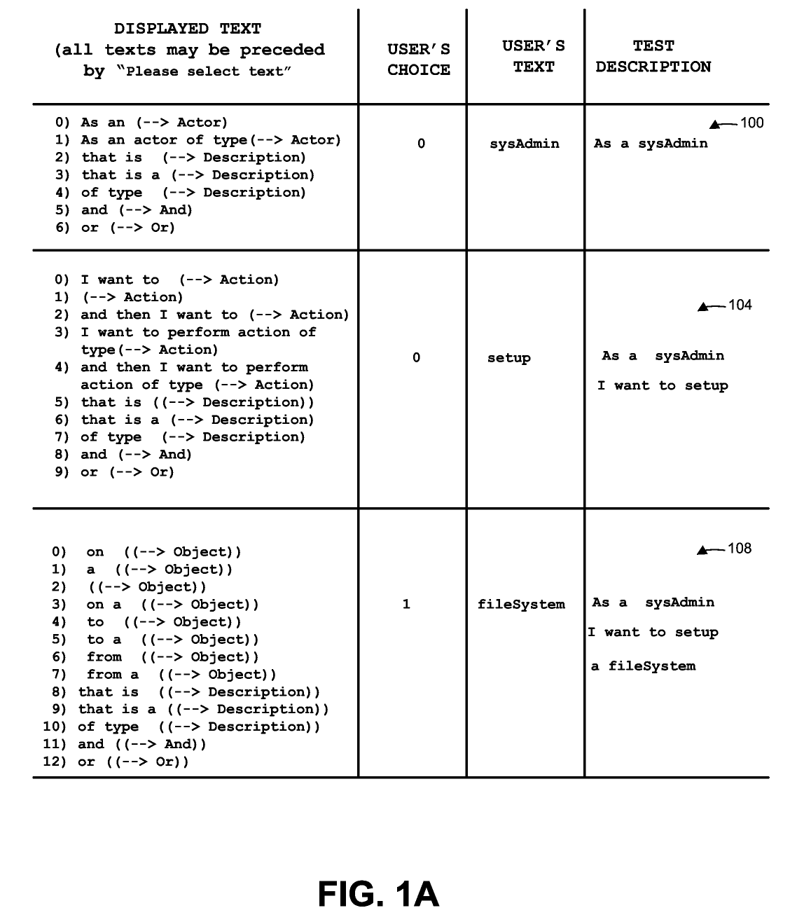

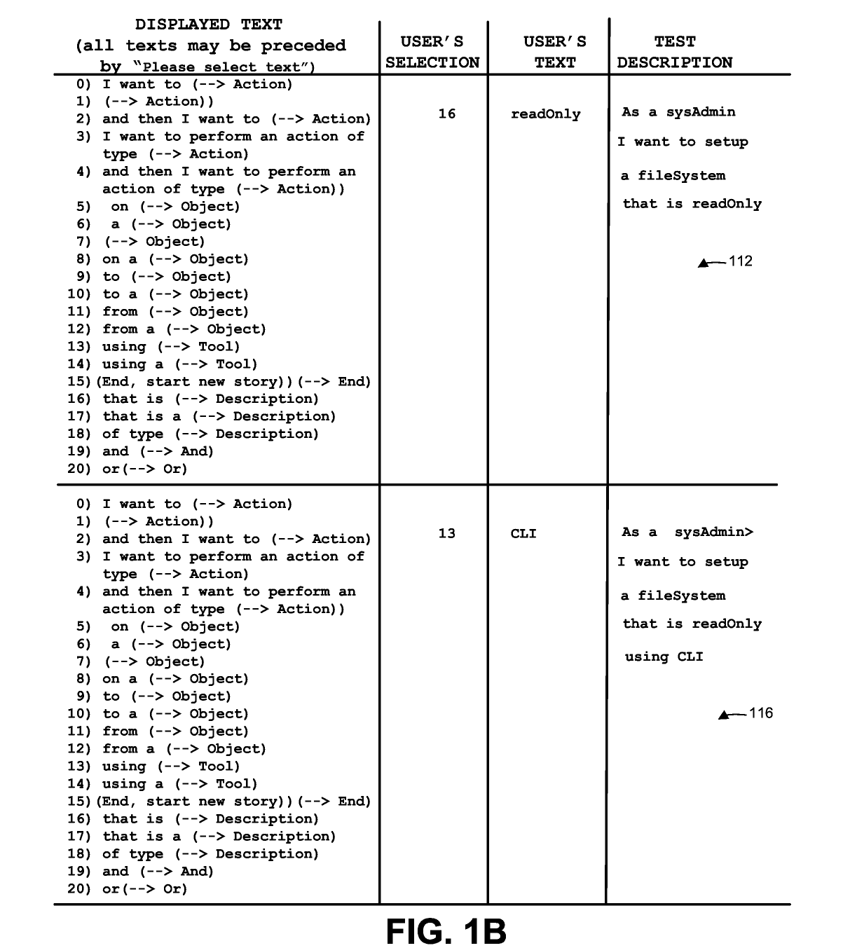

Referring now to FIGS. 1A and 1B, showing an exemplary table of how a test is to be entered by a user using natural language, the table comprising the texts presented to the user, user selections and user entered text, and the resulting test.

On a first step, indicated in row 100, the user is presented with a multiplicity of options related to the type of actor associated with the test to be entered, including an initial option of entering the actor type, continuation options such as “and” and “or”, and options related to auxiliary attributes associated with the action, such as “description”.

The user selected option 0, associated with entering the actor, and when prompted enters the actor type, being a system administrator (sysAdmin). The resulting text “As a sysAdmin” is displayed.

On a second step, indicated in row 104, the user is presented with a multiplicity of options related to the type of action to be performed within the test, including initial options of entering the action type, continuation options such as “and” and “or”, and options related to auxiliary attributes, such as “description”.

The user selects option 0, associated with entering the action, and when prompted enters the action type, being “setup”. The resulting text “As a sysAdmin I want to setup” is displayed.

On a next step, indicated in row 108, the user is presented with a multiplicity of options related to an object to be acted upon within the test, including initial options of entering the object type and various prepositions, such as “on”, “to”, “from” or the like, continuation options such as “and” and “or”, and options related to auxiliary attributes, such as “description”.

The user selects option 1, associated with the action to be performed on an object, and when prompted enters the object, being a file system (fileSystem). The resulting text “As a sys Admin I want to setup a fileSystem” is displayed.

On a next step, indicated in row 112, the user is presented with a multiplicity of options related to an action, a new object to be acted upon, and options related to auxiliary attributes of the object previously selected, such as “description”.

The user selects option 16, associated with the description of the previously selected object, and entered the text of “readOnly”. The resulting test text “As a sys Admin I want to setup a fileSystem that is readOnly” is displayed.

On a next step, indicated in row 116, the user is presented with the same options as in row 112.

The user selects option 13, associated with a tool used in association with the action, and enters the text of “CLI”. The resulting test text “As a sys Admin I want to setup a fileSystem that is readOnly using CLI” is displayed.

It will be appreciated that when entering further tests, texts entered by one or more users may be suggested to future users. For example, whenever a user selects option 13 of row 116, indicating the usage of a tool, the tools entered by previous users, such as “CLI” may be suggested, in addition to the option of entering a new tool name, and further in addition to predetermined values.

It will also be appreciated that the options may be displayed in a hierarchical manner. For example, the options displayed in row 112 may be reduced to action-related options, object-related options, description-related options and the remaining options which may or may not be grouped together. Once the user selected one of the groups, the relevant options may be displayed in a second hierarchical level.

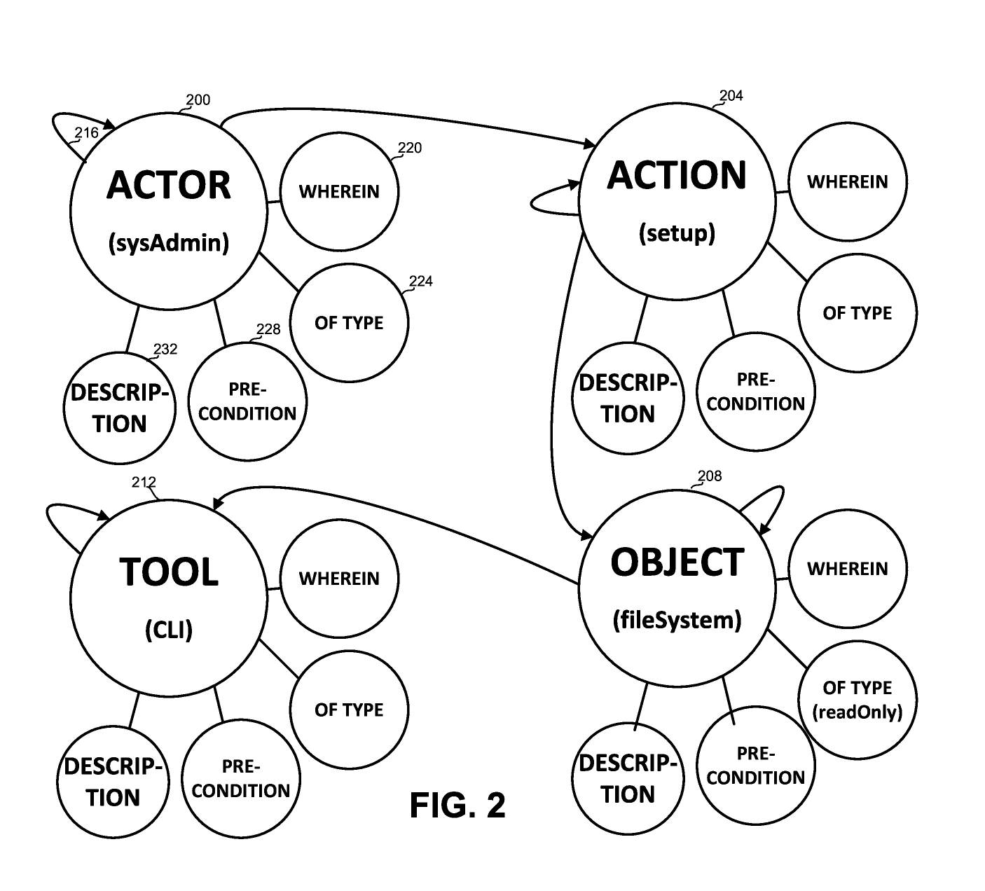

Referring now to FIG. 2, showing an exemplary graph representation of a natural-language generated test.

FIG. 2 shows a graph having four principle nodes, being actor node 200, action node 204, object node 208 and tool node 212, representing four principle attributes. These principle attributes have been identified as common to tests in many systems and disciplines. However, it will be appreciated that the disclosure is not limited to such attributes and other principle attribute collections may be used.

Each of the principle nodes may be associated with one or more auxiliary nodes such as “wherein” node 220 indicating an auxiliary attribute representing a type limitation on a principle node, “of type” node 224 representing an auxiliary attribute of classification of the principle node, a “pre-condition” node 228 representing an auxiliary attribute of a pre-condition on the principle attribute, or “description” node 232 representing an auxiliary attribute of further data related to the principle attribute.

In the exemplary embodiment of FIG. 2, each auxiliary node is associated with a principle node, such that there is no ambiguity of which principle attribute each auxiliary attribute relates to. The uniqueness may be indicated by concatenating the auxiliary attribute name. For example, a description auxiliary attribute of an actor may be named “Actor: description”, while a description auxiliary attribute of an action may be named “Action: description”.

It will be appreciated that different principle nodes may be associated with different sets of auxiliary nodes. For example, a “pre-condition” node may or may not be associated with a “tool” node, while such auxiliary node is highly likely to be associated with an “action” node.

When a user is displayed with options, makes selections and enters text as described in FIGS. 1A and 1B above, the generation of the test may be described as traversing a path in a graph similar to the graph shown in FIG. 2. The values in parenthesis in different nodes in the graph of FIG. 2, such as “sysAdmin” in node 200 represent texts entered by a user in the example of FIGS. 1A and 1B. Selecting an option associated with a principle or an auxiliary node may be described as moving to that node, and entering a value for a node, for example when indicating an actor or an action may be described as associating a value with the node. Thus, each option presented at a particular situation is associated with an edge in the graph connecting the current principle node with another principle node or with an auxiliary node.

It will be appreciated that one or more principle nodes may be associated with self-edges such as self-edge 218 of actor node 200, enabling a user to add a second or further attribute of that type.

It will be appreciated that the user interface and graph representations shown in FIGS. 1A, 1B and 2 represent a particular embodiment of test definition and representation, and that other representations associated with different grammars may be designed and utilized, such as tree representation. The current disclosure relates to any grammar and representation complying with specific grammar, which, optionally together with corresponding user interface, guides a person into entering a natural language test description such that attributes and values may be automatically retrieved from the description.

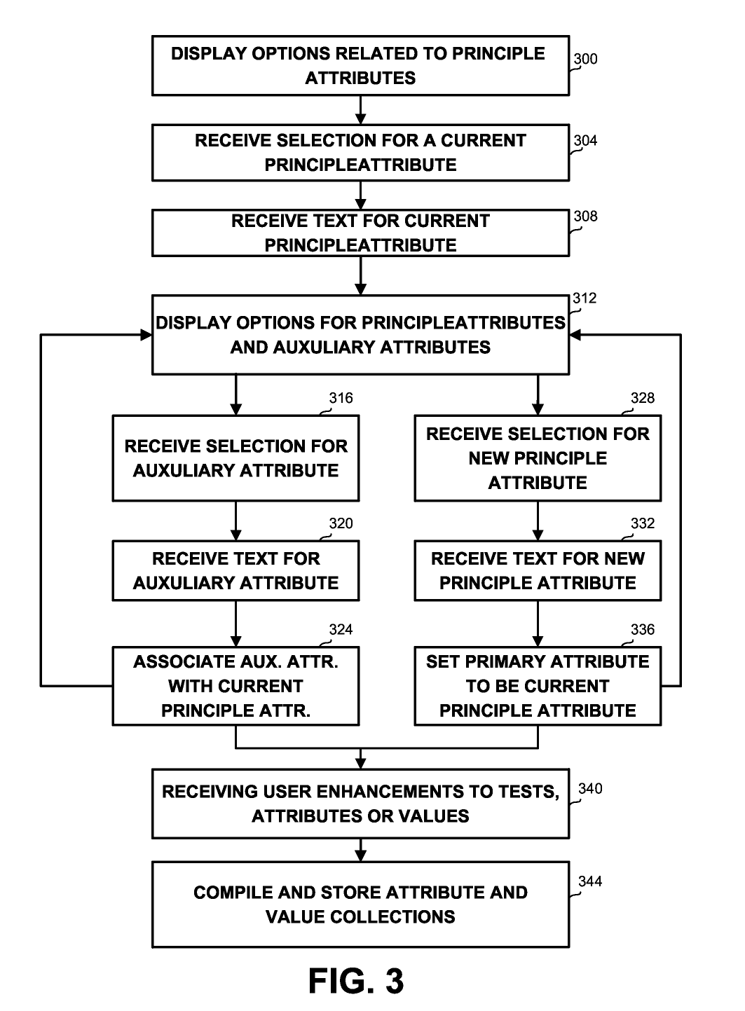

Referring now to FIG. 3 showing a flowchart of steps in a method for receiving a test description entered by a user in natural language wherein the tests can be easily described as a collection of values for attributes, and compiling attribute and value collections.

On step 300, options may be displayed to a user, wherein each option relates to a principle attribute of a test.

On step 304, a selected option may be received from the user, related to one of the options displayed on step 300. The selected option relates to a selected principle attribute, and the selected principle attribute becomes a current principle attribute

On step 308, text may be received from the user, indicating a value for the current principle attribute selected by the user on step 304.

On step 312, options related to principle attributes and auxiliary attributes may be displayed to the user.

If the user selected an option related to an auxiliary attribute, then on step 316, the selection related to an auxiliary attribute selected by the user may be received, and on optional step 320, text may be received from the user, indicating a value for the auxiliary attribute selected by the user on step 316.

On step 324, the auxiliary attribute may be associated with the current primary attribute.

If on step 312 the user selected an attribute related to a principle attribute, on step 328 the selection may be received. On step 332 text may be received which relates to the principle attribute, and on step 336 the selected primary attribute with its value is set to be the current primary attribute.

Step 316, 320 and 324 may be repeated for further auxiliary attributes of the current principle attribute. Step 328, 332 and 336 may be repeated for further principle attributes, each optionally followed by one or more repetitions of steps 316, 320 and 324 for auxiliary attributes associated with each current principle attribute.

It will be appreciated that some principle attributes, such as “action” may be defined as necessary attributes such that a test may not be indicated as complete before values have been assigned to these attributes.

On step 340, a user may be provided with an option to review, enhance, amend, add, delete or introduce any other changes to one or more tests, principle attributes, auxiliary attributes, values, or the like. The amendments may then be received from the user, and one or more tests, principle attributes, auxiliary attributes or values may be enhanced.

It will be appreciated that the steps above may be executed in any order. For example, auxiliary attributes may be added to earlier-generated principle attributes and not only to a current principle node, new tests may be added after a user has reviewed the attributes and values, or the like. Thus, a text description may be created based upon one or more principle attributes and optionally one or more auxiliary attributes, and later enhanced with values for one or more principle attributes or one or more auxiliary attributes.

On step 344, a collection of values may be compiled for each principle attribute and each auxiliary attribute. Step 344 may also be performed before or after any other step, such that the existing values for various attributes may be suggested to a user that selected the respective attribute. In some embodiments, an initial value collection may be provided and displayed to a user to select from, possibly in addition to values entered in association with other tests, or in addition to the option to enter new values.

It will be appreciated that once a test is entered, it may be represented as a set of values for attributes, including principle and optionally auxiliary attributes.

Once the possible values for the various attributes are available, the Cartesian product of the values may be determined, including indications on restrictions, preferred value combinations, forbidden combinations, or the like.

When a multiplicity of test representations is available, it may be used by tools such as combinatorial test designing tools, coverage analysis tools, or the like.

It will be appreciated that the disclosure relates also to a user being presented with a free-text existing test suite comprising one or more tests, wherein the user converts existing tests in accordance with the disclosure and optionally with a corresponding user interface, into attribute-value form tests. The resulting scenarios may be used for generating tests, or selecting from the existing tests.

It will be appreciated that the disclosure relates also to receiving and parsing a text representing a test, wherein the text comprises indications for principle attributes and associated values, and optionally auxiliary attributes associated with any of the principle attributes. Some pre-determined attributes, such as “actor”, may be pre-determined to be principle attributes, while other attributes may be explicitly indicated as principle attributes. Yet other attributes may be assumed to be auxiliary attributes each related to an indicated principle attribute, to the last preceding principle attribute, or the like.

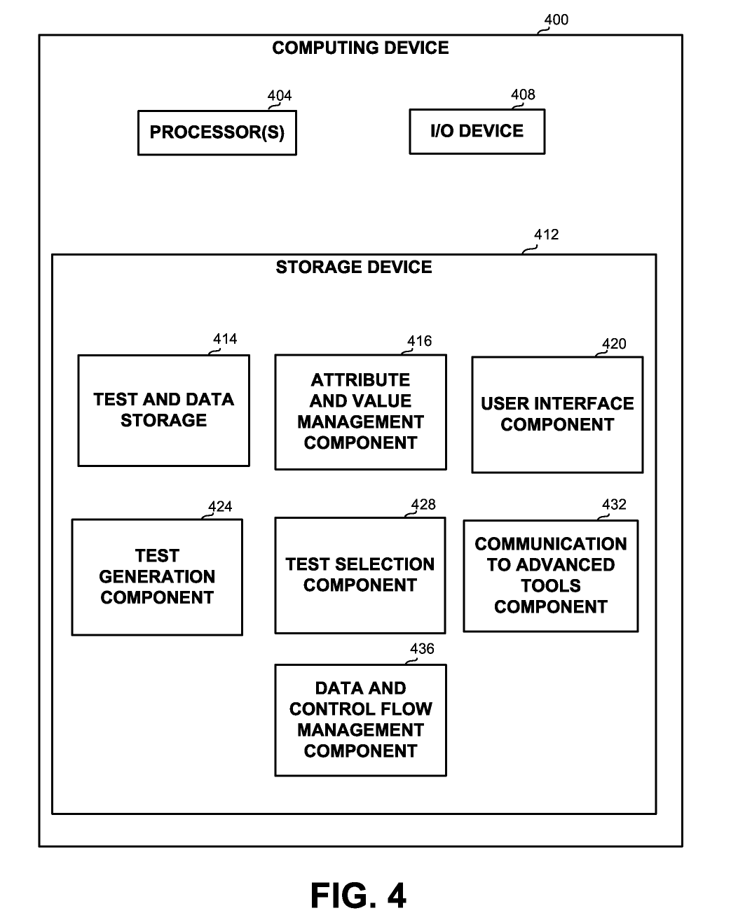

Referring now to FIG. 4, showing a block diagram of components of an apparatus for entering tests in natural language, wherein each tests can be automatically described as a collection of values for attributes.

The apparatus may comprise a computing platform 400. Computing platform 400 may comprise a processor 404. Processor 404 may be a Central Processing Unit (CPU), a microprocessor, an electronic circuit, an Integrated Circuit (IC) or the like. Alternatively, computing platform 400 can be implemented as firmware written for or ported to a specific processor such as digital signal processor (DSP) or microcontrollers, or can be implemented as hardware or configurable hardware such as field programmable gate array (FPGA) or application specific integrated circuit (ASIC). Processor 304 may be utilized to perform computations required by computing platform 400 or any of it subcomponents.

In some embodiments, computing platform 400 may comprise an input-output (I/O) device 408 such as a terminal, a display, a keyboard, an input device or the like, used to interact with the system, to invoke the system and to receive results.

In some exemplary embodiments, computing platform 400 may comprise one or more storage devices such as storage device 412. Storage device 412 may be persistent or volatile. For example, storage device 412 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, storage device 412 may retain program code operative to cause processor 404 to perform acts associated with any of the steps shown in FIG. 3 above.

The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Storage device 412 may comprise test and data storage 414, storing one or more collections of principle attributes, auxiliary attributes associated with each principle attribute, optionally one or more values associated with each principle or auxiliary attribute, text associated with each attribute, or the like. Test and data storage 414 may also comprise previously entered tests, each represented for example as a collection of values for attributes, as text, or using any other representation.

Storage device 412 may also comprise attribute and value management component 416 for maintaining a collection of initially provided values or user-entered values for each attribute and user-provided values for the attributes.

Storage device 412 may further comprise User Interface (UI) component 420 which may be utilized to provide communication between the apparatus and a user, for displaying the relevant options to the user, receiving user selections and user-input text, or the like.

Storage device 412 may comprise test generation component 424, for generating a test based upon the user-provided selections and texts. Test generation component 424 may comprise an internal-representation component for maintaining an internal representation of the test, for example in the form of a graph.

Storage device 412 may further comprise test selection component 428, for selecting a subset of the generated tests, which provides the required coverage with higher efficiency as compared to performing all tests.

Storage device 412 may also comprise communication to advanced tools component 432 for providing test descriptions to advanced testing tools, such as combinatorial test design tools, coverage analysis tools, or the like.

Storage device 412 may also comprise data and control flow management component 436 for managing the flow of information and control between other components, for example storing the selections and values received by user interface component 420, test generation component 424, test selection component 428, or the like.

The disclosed method and apparatus provide for receiving from a user test descriptions, wherein the descriptions are provided in natural language but are easily translatable to forms such as attribute-value form that can be used with advanced test planning systems. The natural language usage makes it easy to a user who is an expert in the field but not necessarily an expert in testing methodologies to enter valuable tests, while maintaining the tests usability.

The disclosed method and apparatus enable the generation of tests in accordance with user-provided coverage requirements. The disclosed method and apparatus is operative in providing the required coverage with a reduced number of tests to enhance efficiency.

It will be appreciated that multiple enhancements and modifications may exist to the method and apparatus.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method performed by a computerized device, comprising:
displaying to a user at least two options related to at least one principle attribute of a test;
receiving from the user selection for an option related to a principle attribute;
receiving from the user a value for the principle attribute; and
generating a description of the test, the description comprising the value for the principle attribute.

2. The computer-implemented method of claim 1 further comprising:
displaying to the user at least one option related to at least one auxiliary attribute associated with the principle attribute;
receiving from the user a selection for an option related to the auxiliary attribute;
receiving from the user a second value for the auxiliary attribute; and
enhancing the description of the test with the second value for the auxiliary attribute.

3. The computer-implemented method of claim 2, further comprising compiling collections of values to the principle attribute and to the auxiliary value.

4. The computer-implemented method of claim 2, wherein the auxiliary attribute is selected from the group consisting of: a description, a precondition, and a type.

5. The computer-implemented method of claim 1, further comprising receiving from a user amendments to a test, a principle attribute, an auxiliary attribute, or a value associated with a principle attribute or an auxiliary attribute.

6. The computer-implemented method of claim 1, further comprising compiling a collection of values to the principle attribute.

7. The computer-implemented method of claim 1, wherein the description of the test is used as input to a combinatorial test design tool or to a test analysis tool.

8. The computer-implemented method of claim 1, wherein the principle attribute is selected from the group consisting of: an actor, an action, an object and a tool.

9. A computer-implemented method performed by a computerized device, comprising:
receiving a text representing a test; and
parsing the text to obtain:
at least one principle attribute and an associated first value, and
at least one auxiliary attribute and an associated second value, the at least one auxiliary attribute associated with one of the at least one principle attribute.

10. An apparatus having a processing unit and a storage device, the apparatus comprising:
a user interface component for receiving from a user a selection related to a principle attribute and a value for the principle attribute; and
a test description generation component for generating a test description, the test described as the value for the principle attribute.

11. The apparatus of claim 10 wherein the user interface component is further adapted to receive from a user a selection related to an auxiliary attribute and a second value of the auxiliary attribute, and wherein the test is described as the value for the principle attribute and the second value for the auxiliary attribute.

12. The apparatus of claim 10 further comprising a communication to advanced tools component for providing the test to an advanced test planning tool.

13. The apparatus of claim 10 further comprising an attribute and value management component for managing values for the principle attribute and for auxiliary attribute.
